(19) United States
(12) Patent Application Publication
(10) Pub. No.: US 2012/0117960 A1
(43) Pub. Date: May 17, 2012

(54) ENERGY HARNESSING DEVICE

(76) Inventor: Graham Browne, Preston (GB)

(21) Appl. No.: 13/322,747

(22) PCT Filed: May 28, 2010
(86) PCT No.: PCT/GB2010/001080

§ 371 Date: Feb. 2, 2012

(30) Foreign Application Priority Data
May 28, 2009 (GB) 0909105.9

(51) Int. Cl. F03B 13/12

(52) U.S. Cl. 60/495

(57) ABSTRACT

An energy harnessing device comprising a substantially helical conduit which in use is arranged to float in a body of water including regions of varying pressure, which may for example arise due to wave motion, tidal motion and/or current flow. The conduit defines a fluid flow path along its length and comprises a fluid inlet and a fluid outlet in fluid communication via said fluid flow path. The conduit is arranged to rotate about its longitudinal axis by the action of water of varying pressure contacting the helical conduit and driving fluid(s) along the fluid flow path. A method of harnessing energy from a body of water including regions of varying pressure is also described.

The present invention relates to an energy harnessing device, particularly an energy harnessing device for harnessing energy from a body of water experiencing fluid flow resulting from wave motion, tidal motion and/or as a result of a current flow.

Harnessing the power of the motion of a body of water has long been viewed as a potential source of renewable energy. A body of water, for example, the sea, undergoes two main types of motion which cause the depth of the sea relative to the sea bed to change. These are wave motion and tidal motion. Tidal motion is caused by the combined effect of the earth's rotation and gravitational forces exerted on the sea by the moon and the sun. Tidal motion has a period of approximately twelve and a half hours. Wave motion may be caused by various forces including the wind and the Coriolis force. Such waves may be known as surface waves or weather induced waves. Wave motion has a period which is dependent on many factors and as such it will be different for different parts of the sea. In addition, successive surface or weather induced waves at the same location can differ in both height and duration. Considerable differences in the characteristics of surface or weather induced waves can occur during calm and rough weather conditions. In general, the period of wave motion is less than 30 seconds. Bodies of water, such as streams and rivers, experience another type of motion in the form of a current flow.

One known type of device for harnessing the energy of wave or tidal motion is a reciprocating buoyant platform. In this type of energy harnessing device the buoyant platform floats on the surface of the sea and the wave or tidal motion of the sea causes the buoyant platform to move up and down relative to the sea bed. The reciprocating motion of the buoyant platform relative to the sea bed may be used to drive, for example, an electrical generator or pump. Known electrical generators commonly require a rotational input motion in order to function. Converting the reciprocal motion of the buoyant platform into rotational motion required by the electrical generator may require a complex and/or unreliable linkage.

Another known type of energy harnessing device is a “screw”-type device. These comprise a generally screw-shaped member which floats at the surface of a body of water. As water moves past the screw member, for example resulting from wave motion, the drag effect of water flow along the screw surface causes the screw member to rotate. This rotating motion of the screw member can then be used to power an electrical generator. Such devices can, however, be inefficient because water within a body of water experiencing wave motion does not flow linearly along the longitudinal axis of the screw. Rather, it moves forwards and backwards slightly during a complete cycle of wave motion. As a result, the screw oscillates longitudinally at the same time as rotating in one direction and then to a lesser extent back in the opposite direction. Thus, while there is a net rotation in one direction by which wave energy can be harnessed, the longitudinal oscillation and reverse rotation reduce the energy harnessing efficiency of these types of devices.

Other prior art devices endeavour to harness wave energy by relying simply upon the weight of the moving body of water to drive a water wheel. While devices based on this principle can be relatively simple they lack efficiency. In an effort to improve efficiency, more sophisticated devices have been developed which employ floating articulated structures in which adjacent sections are linked by hinged joints. The wave-induced motion of the joints is resisted by hydraulic rams, which pump fluid through hydraulic motors to generate power. Arrangements of this kind are, however, inherently complicated and are therefore relatively expensive to construct and maintain, and may be more unreliable than simpler devices.

It is desirable to provide an energy harnessing device which is more effective at harnessing energy from the motion of a fluid body resulting from waves, tides and/or currents compared to known energy harnessing devices. It is also desirable to provide an energy harnessing device which obviates or mitigates at least one of the disadvantages of known energy harnessing devices.

According to a first aspect of the present invention there is provided an energy harnessing device comprising a substantially helical conduit which in use is arranged to float in a body of water including regions of varying pressure, the conduit defining a fluid flow path along its length and comprising a fluid inlet and a fluid outlet in fluid communication via said fluid flow path, said conduit being arranged so as to be rotatable about its longitudinal axis by the action of water of varying pressure contacting said helical conduit and driving fluid(s) along said fluid flow path.

An energy harnessing device according to the invention hence provides a more effective way of harnessing the energy of a body of fluid, such as water, experiencing wave motion, tidal motion and/or current flow. An energy harnessing device according to the present invention also has a simple construction which may make the energy harnessing device more reliable, less expensive and time consuming to manufacture and maintain, and easier to deploy.

A second aspect of the present invention provides a method of harnessing energy from a body of water including regions of varying pressure, the method comprising
i. floating a device comprising a substantially helical conduit in said body of water, the helical conduit defining a fluid flow path along its length and comprising a fluid inlet and a fluid outlet in fluid communication via said fluid flow path,
ii. introducing fluid(s) of varying pressure into said conduit so as to occupy at least a portion of said fluid flow path, and
iii. arranging the helical conduit containing the fluid(s) of varying pressure to be contacted by said body of water of varying pressure so as to cause the helical conduit to rotate about its longitudinal axis and drive the fluid(s) of variable pressure along said fluid flow path.

Preferably the substantially helical conduit is adapted to accommodate fluid(s) of varying pressure to be driven along the internal fluid flow path defined by the inside of the helical conduit, and also to accommodate fluid(s) of varying pressure to be driven along an external flow path defined around the outside of the helical conduit. The fluid(s) of varying pressure driven along the internal fluid flow path inside the helical conduit may comprise alternating pockets of relatively high pressure fluid and relatively low pressure fluid, such as alternating pockets of a gas e.g. air and a liquid e.g. water, a convenient source for the liquid being the body of water in which the device floats and a convenient source for the gas being atmospheric air above the body of water.

In a preferred embodiment the pitch of the helical conduit member should be configured to approximately match a predicted average wavelength of the body of water when including regions of varying pressure arising from wave motion. In this way, regions of high and low pressure fluid (e.g. air and water) distributed along the fluid flow path within the conduit as a result of their natural tendency to lie higher or lower will seek to match and tune into the periodicity of high and low pressure regions within the body of water subject to wave motion. As high pressure water outside the conduit (a wave peak) contacts a surface of the conduit enclosing a low density region of the fluid(s) within the conduit, that section of the conduit will be forced away while the neighbouring section of the conduit containing higher density fluid will be pumped along the conduit by displacement forces. This and other mechanisms which influence operation of the device of the present invention are explained in greater detail below. In view of the above and taking into account environmental and economic factors affecting a particular location, the helical pitch of the helical conduit member is preferably at least around 20 m, more preferably at least around 40 m, still more preferably at least around 60 m, and yet more preferably around 80 to 100 m or more. The aforementioned figures are appropriate for use of the device of the present invention in offshore deep sea applications. It will be appreciated that in near shore applications lower figures may be more appropriate, that is, for these applications it may be preferred that the helical pitch of the helical conduit member is smaller, for example, at least around 5 to 10 m, more preferably at least around 15 to 25 m.

It is preferred that the longitudinal length of the helical conduit member is greater than or equal to the predicted average wavelength of the body of water when including regions of varying pressure arising from wave motion. Moreover, the pitch of the helical conduit member is preferably configured to be less than or equal to a predicted maximum wavelength of the body of water when including regions of varying pressure arising from wave motion. In this way the device can exploit the energy of the body of water to the greatest possible extent across changing environmental conditions and ensure a smooth, continuous supply of energy.

The helical conduit may possess a longitudinal length of any desirable value. In order to maximise energy harnessing it may be desirable to make the helical conduit as long as economically and environmentally feasible for a given application and taking into account the predicted average and maximum wave lengths and wave heights, tidal ranges or current flow characteristics of the body of water in which the device is to be deployed. Typically, it is preferred that the helical conduit possesses a longitudinal length of at least around 25 m, more preferably at least around 50 m, still more preferably at least around 75 m. The helical conduit may have a longitudinal length of at least around 100 m, at least around 150 m or around 200 m or more. The aforementioned figures are appropriate for use of the device in offshore deep sea applications. It will be appreciated that in near shore applications lower figures may be more appropriate, for example, longitudinal lengths of at least around 5 to 10 m, more preferably at least around 15 to 25 m may be preferred.

The helical conduit may possess any appropriate diameter and/or cross-sectional area subject to environmental and economic constraints and again giving due consideration to the predicted average and maximum wave lengths and wave heights, tidal ranges or current flow characteristics. A diameter of at least around 1.5 m is preferred, more preferably at least around 2.5 m, still more preferably at least around 5 m, and yet more preferably around 7.5 m or larger. It is preferred that the diameter is no less than around 0.5 to 1 m. A preferred cross-sectional area for the helical conduit is at least around 1.75 m², more preferably at least around 5 m², still more preferably at least around 20 m², and yet more preferably at least around 45 m². Again, the aforementioned figures for the diameter and cross-sectional area of the helical conduit are appropriate for use of the device in offshore deep sea applications. In near shore applications lower figures may be more appropriate, for example, diameters of at least around 0.25 to 0.5 m, more preferably at least around 0.75 to 1.5 may be preferred.

The helical conduit may incorporate any portion or number of complete helical turns. It is preferred that the helical conduit incorporates one or more helical turns, more preferably it incorporates two or more helical turns.

The helical conduit may be constructed so as to have sufficient structural strength to enable it to be essentially self-supporting so that it can retain its intended substantially helical form throughout operation. Alternatively, the device may comprise at least one support member configured to support the helical conduit. Any appropriate type of support or supports may be used. Preferably the at least one support member is a buoyant body, for example a sealed hollow structure, such as a tube, extending parallel to the longitudinal axis of the helical conduit. In preferred embodiment, the at least one support member extends coaxially with respect to the longitudinal axis of the helical conduit. In addition or as an alternative to the support member(s), the device may incorporate one or more floats which may be adjustable to facilitate control of the buoyancy of the device.

In order to maximise energy harnessing in a particular application the depth to which the device is submerged below the water line should be determined. It is preferred that the device is adapted to float in the body of water so that at least around 25% of the volume of the helical conduit is submerged below the average water line, more preferably so that at least around 50% of the volume of the helical conduit is submerged below the average water line, still more preferably so that around 75 to 100% of the volume of the helical conduit is submerged below the average water line. An optimum configuration may have around 70 to 90% of the volume of the helical conduit submerged below the average water line. In other applications, it may be more appropriate to fully submerge the helical conduit so that substantially the whole volume of the helical conduit is submerged below the average water line.

In a preferred embodiment the helical conduit is configured so that at least one, more preferably both, of the fluid inlet and the fluid outlet is radially offset from the longitudinal axis of the helical conduit. At least one of the fluid inlet and the fluid outlet may be open to the surrounding environment. In this case, it is preferred that the fluid inlet is open to the surrounding environment so as to allow alternating volumes of air and water to flow into the fluid flow path defined by the helical conduit during rotation of the helical conduit. These alternating ‘slugs’ of air and water can then occupy the conduit and form the alternating pockets of high and low pressure fluid which can then be acted upon by the different pressure regions of the body of water in which the device is floating to cause rotation of the helical conduit and pump the air and water slugs along the fluid flow path. To improve the ability for the fluid inlet to capture the slugs of air and water it is preferred that the fluid inlet is defined by a protrusion extending radially outwardly from the helical conduit. To further optimise performance of the device the fluid outlet may be provided with at least one constriction to restrict fluid flow out of the fluid flow path defined by the helical conduit. As explained in greater detail below, this may produce a back pressure which will increase the pressure of the air and water slugs within the conduit and increase the turning force which they can apply against the inner wall of the helical conduit. It may be preferable for the fluid outlet to be in fluid communication with the fluid inlet via a return conduit, separate to the helical conduit, the return conduit defining a return fluid flow path for fluid to flow from said outlet to said inlet. Such a design may represent an essentially ‘closed-system’. In this embodiment, the helical conduit may be initially charged with the slugs of air and water by use of a pumping apparatus or by initially opening the inlet to the surrounding environment and manually rotating the device until the helical conduit is adequately charged with slugs of air and water and then closing the inlet so as to connect it to the return conduit whereupon rotation of the device would be driven by energy from surrounding waves, tides or current flow.

It is preferred that the helical conduit is tethered to restrict displacement of the helical conduit along its longitudinal axis and/or out of the horizontal plane. Any appropriate means of tethering may be employed but it is preferred that it is effected by at least one line, cable or the like being secured to a fixed structure, such as a buoy, anchor, pylon or the floor supporting the body of water in which the device is floating, e.g. the sea, river or tidal estuary bed. It is convenient if the tethering line(s) is connected to the support member which supports the helical conduit. The at least one line is preferably connected to the device via a rotational joint, such as a bearing, to facilitate rotation of the helical conduit about its longitudinal axis. Moreover, it is preferred that the tethering facilitates pivoting of the device within a horizontal plane about the fixed structure to which it is secured, while preferably restricting movement of the device out of the horizontal to optimise energy harnessing efficiency. As described more fully below, this enables the device to self-orientate itself when the length of incident waves falls below its predicted average such that the helical pitch of the helical conduit is now longer than the length of incoming waves. The device can pivot horizontally until such time as the length of the component of the helical pitch of the helical conduit substantially matches the length of the incoming waves. To achieve this effect it may be preferable to design the outer surface of the device facing the prevailing waves to offer minimal drag so that drag forces across the outer surface of the device do not predominate over the effect arising from matching the spacing between adjacent slugs of air and water to the spacing between adjacent wave peaks and troughs.

To optimise performance of the device it preferably comprises a plurality of helical conduits which are longitudinally and/or radially spaced apart from one another. The device may incorporate first and second helical conduits which are longitudinally spaced from one another, said first and second helical conduits preferably possessing substantially the same helical pitch. In this case, it is preferred that the first and second helical conduits are separated by a longitudinal spacing equivalent to approximately half the helical pitch of the helical conduits.

In order to convert the energy harnessed from waves, tides, and/or current flow it is preferred that a transducer is operatively connected to the substantially helical conduit. Any appropriate transducer may be employed, as discussed in greater detail below. In a preferred embodiment, the transducer is located within the support member which supports the helical conduit. In this embodiment, the transducer may be located towards the rear end of the support member opposite to the end which is attached to the tether. In this case, it may be convenient to run a power takeoff cable from the rear mounted transducer along the inside of the support member and off the device via the tether, either by being provided within the tether or by being connected to it in some way.

As stated above, the second aspect of the present invention relates to a method of harnessing energy from a body of water including regions of varying pressure.

The fluid(s) of varying pressure occupying at least a portion of the fluid flow path defined by the helical conduit preferably comprise alternating pockets of relatively high pressure fluid and relatively low pressure fluid, such as alternating pockets of air and water, which may be conveniently sourced from the surrounding environment.

The extent to which the floating device is submerged below the average water line of the body of water can be chosen to suit a particular application by, for example, changing the buoyancy of the device. It is thus possible to adjust the level to which the device is submerged to optimise energy harnessing efficiency in any given body of water, whether experiencing wave motion, tidal motion or current flow. The device is preferably floated in the body of water so that at least around 25% of the volume of the helical conduit is submerged below the average water line, more preferably so that at least around 50% of the volume of the helical conduit is submerged below the average water line, still more preferably so that around 75 to 100% of the volume of the helical conduit is submerged below the average water line. An optimum configuration may have around 70 to 90% of the volume of the helical conduit submerged below the average water line. In other applications, it may be more appropriate to fully submerge the helical conduit so that substantially the whole volume of the helical conduit is submerged below the average water line.

The method preferably comprises tethering the helical conduit to a fixed structure to restrict displacement of the helical conduit along its longitudinal axis. Said tethering may be effected so as to facilitate rotation of the helical conduit about its longitudinal axis relative to said fixed structure and/or to facilitate substantially horizontal pivoting of the device relative to said fixed structure.

The fluid inlet is preferably open to the surrounding environment so that during rotation of the helical conduit alternating volumes of air and water can flow into the fluid flow path defined by the helical conduit.

The fluid outlet may be in fluid communication with the fluid inlet via a return conduit which defines a return fluid flow path for fluid to flow from said outlet to said inlet during rotation of the helical conduit.

It is preferred that energy harnessed from the body of water by rotation of the helical conduit is passed to a transducer to convert said energy into another form of energy.

Other preferred features of the invention will become apparent from the description below.

Specific embodiments of the present invention will now be described, by way of example only, with reference to the accompanying drawings, in which:—

FIG. 1 shows a schematic side elevation of an energy harnessing device in accordance with a first embodiment of the present invention;

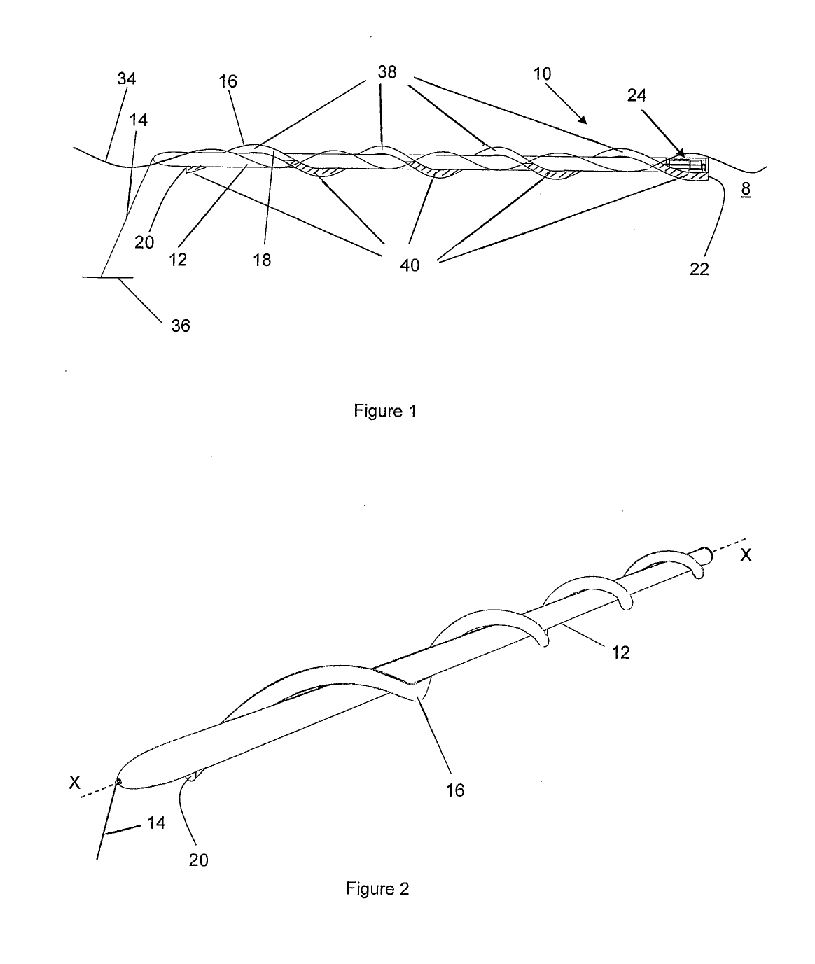

FIG. 2 shows a schematic perspective view of the energy harnessing device shown in FIG. 1;

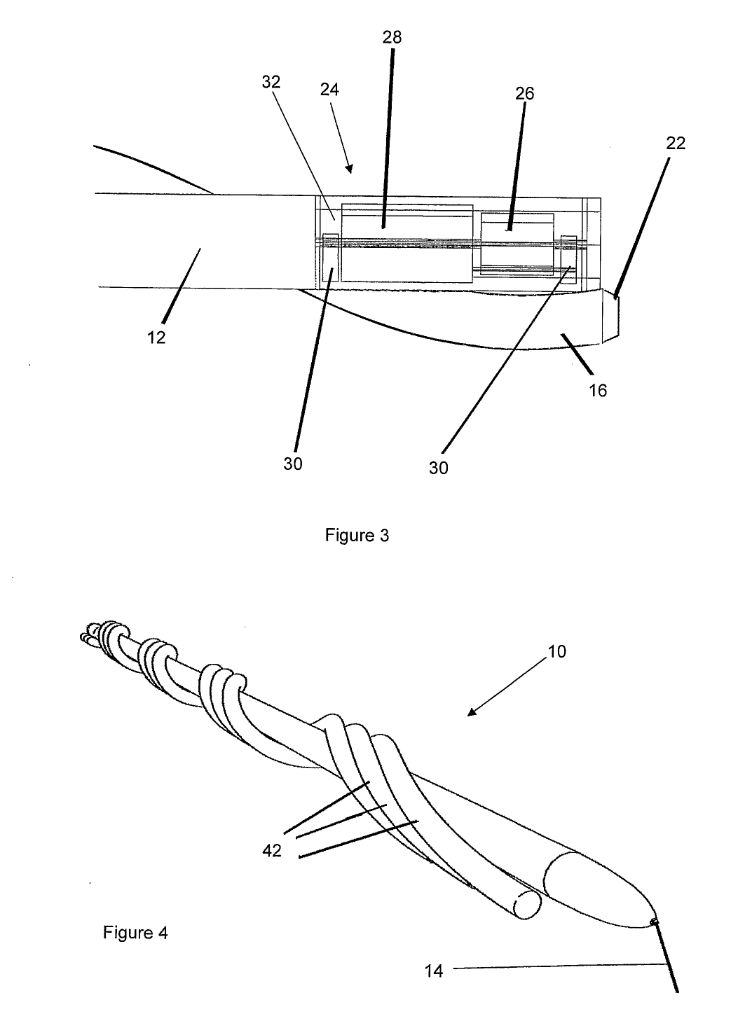

FIG. 3 shows a schematic cross-sectional view through a transducer end of the energy harnessing device shown in FIGS. 1 and 2; and

FIG. 4 shows a schematic perspective view of an energy harnessing device in accordance with a second embodiment of the present invention.

FIGS. 1 and 2 show an energy harnessing device in accordance with an embodiment of the present invention. The energy harnessing device 10 comprises an elongate support member 12 which is attached at one end to a tether 14. The support member 12 is generally cylindrical and supports a helical conduit member 16. The conduit member 16 is disposed upon the support member 12 such that its helical axis is co-axial with the longitudinal axis of the support member 12. The axis shared by the support member 12 and helical conduit member 16 is indicated by X in FIG. 2. The helical conduit member 16 can be likened to a tube which is coiled around the support member 12. The conduit member 16 has an exterior surface which is screw-like. The conduit member 16 also comprises a helical conduit 18 within the conduit member 16 which is defined by an inner surface of the conduit member 16. The conduit 18 has an opening 20,22 at each of its ends: an opening 20 at an end of the conduit 18 closest to the tether 14 and an opening 22 at an opposite end of the conduit 18.

The energy harnessing device 10 also comprises a transducer portion 24 at the end of the support member 12 which is remote from the tether 14. As can be seen most clearly in FIG. 3, the transducer portion 24 comprises a gearbox 26 which links the support member 12 to an alternator 28. The gearbox 26 and alternator 28 are rotationally mounted within a water tight chamber 32 within the transducer portion 24 so that they may rotate relative to the support member 12 about axis X. The gearbox 26 and alternator 28 are also provided with counterweights 30 which ensure that if the support member 12 rotates about axis X then the gear box 26 and alternator 28 do not rotate with it. This is because the counterweights 30 are continually urged by gravity into the lowest possible position (in terms of vertical height). The alternator 28 is also provided with a power output (not shown). The power output may take the form of a cable which runs from the transducer portion 24 of the energy harnessing device 10 along the support member 12 to the tether 14. The cable may then be attached to the tether 14 and fed to a location where any electrical power which is generated by the alternator 28 can be utilised or stored. Alternative arrangements for transmitting power from the device 10 may also be used.

The support member 12 is buoyant so that the energy harnessing device 10 may be floated on a body of water 8. The body of water 8 may be a sea, an ocean or any suitable body of water which experiences wave motion. FIG. 1 shows the energy harnessing device 10 floating at a surface 34 of the body of water 8. When the energy harnessing device 10 is floated on the body of water 8, the tether 14 may be secured to a suitable anchor point 36 such as a sea bed in the case where the body of water is a sea. The tether 14 may be secured directly to the structure supporting the body of water, e.g. the sea bed, or may be attached to an intermediate structure such as a platform, pylon or the like. Alternatively, the tether 14 may be secured to a float which is arranged to prevent substantial axial movement of the device 10 along axis X.

As previously mentioned, large bodies of water, such as a sea, undergo wave motion which causes the depth of the body of water to change relative to the structure or floor which supports it. Wave motion may be caused by various forces including the wind and the Coriolis force. The tether 14 is flexible such that it allows the orientation of the energy harnessing device 10 on the surface 34 of the body of water 8 to change. The force of the wave motion of the body of water 8 on the external surface of the conduit member 16 causes the energy harnessing device 10 to automatically orientate itself so that the axis X is substantially parallel to the direction in which the waves are travelling, i.e. generally perpendicular to the wavefronts which result from the wave motion of the body of water 8, which may be the relative orientation at which the energy harnessing device 10 is most efficient at harnessing the wave energy of the body of water 8. This may be advantageous in some embodiments of the invention because it means that natural changes in the direction of the wave motion, which can occur over time, can be accommodated and power generation maximised throughout these changing conditions.

The device 10 of the present invention has also been designed to self-optimise its orientation relative to the direction of the incoming waves to maximise power generation as the length of incident waves changes. Maximum energy harnessing is achieved when the pitch of the helical conduit member 16 approximately matches the average wavelength throughout the body of water 8 in which the device 10 is floating. Since the pitch of the helical conduit member 16 is fixed, as the length of incident waves shortens, this optimal relationship is lost. To address this problem, the device 10 is designed to enable it to automatically realign itself so that as wavelengths shorten, the device 10 pivots about the tether 14 so that the axis X is no longer substantially parallel to the direction of wave motion, but is instead offset to a sufficient angle such that the component of the pitch of the helical conduit member 16 extending parallel to the direction of wave motion more closely matches the shorter wavelength of the incoming waves.

As explained in greater detail below, the energy harnessing device 10 of the present invention is designed to exploit wave motion through the body of water 8 in which the device 10 is deployed so that it exerts rotational forces on the device 10 thereby causing the device 10 to rotate about its axis X. The device 10 is provided with a rotational joint, such as a bearing (not shown), which links the support member 12 to the tether 14. Because of the rotational joint, it is possible for the support member 12 and hence the device 10 to rotate relative to the tether 14 about axis X. Rotation of the device 10 causes the support member 12 and hence the transducer portion 24 to rotate. Because the gearbox 26 and alternator 28 are acted on by the counter weights 30, they remain substantially stationary within the chamber 32, whilst the support member 12 rotates relative to them. The support member 12 is linked to the alternator 28 via the gearbox 26 so that the rotation of the support member 12 relative to the alternator 28 causes the alternator 28 to generate electrical power. This electrical power may then be transported away from the device 10 using the output cable (not shown) in any desirable arrangement.

The energy harnessing device 10 captures energy from wave motion using a combination of mechanisms which are now described.

Wave motion through a body of water is characterised by alternating regions of relatively high pressure under a wave peak and relatively low pressure under a wave trough. It can be seen in FIG. 1 that the energy harnessing device 10 floats on the surface 34 of the body of water 8 so that approximately half of the support member 12 (and attached conduit member 16) is submerged beneath the water level 34 and approximately half of the support member 12 (and attached conduit member 16) is above the water level 34. The openings 20,22 of the conduit 18 are located off-centre from the axis X. As a result, as the support member 12 and attached conduit member 16 undergo a complete rotation around the axis X, for part of the rotation the openings 20, 22 will be at least partially submerged and for part of the rotation the openings 20, 22 will be at least partially above the water level 34. Depending upon what part of the rotation cycle the support member 12 and conduit member 16 are undergoing, the openings 20, 22 will be exposed to water and/or air. Both air and water may thus be admitted to the conduit 18 during rotation of the device 10. During rotation, the conduit 18 acts in a similar manner to a screw pump, whereby water and air are drawn in at the opening 20 facing the incident waves and then pumped along the conduit 18 to the opening 22 at the opposite end of the device 10 where the water and air exits the conduit 18. Due to the fact that water is heavier than air, it can be seen that as the water and air pass through the conduit 18 they separate into generally alternating pockets of air 38 and water 40: the air pockets 38 being located above the water pockets 40. It will be appreciated that the air within the conduit 18 may increase the buoyancy of the energy harnessing device 10, which will then need to be compensated for in the configuration of the support member 12 and any additional buoyancy aids which may be present (not shown). At the outset, it may be necessary to rotate the device 10 manually one or more times to charge the conduit 18 with a sufficient number of air and water pockets 38, 40 so that the natural wave motion can then subsequently drive rotation of the device 10 as explained below. Alternatively, or in addition, the conduit 18 may be charged with air and water pockets 38,40 by pumping air and water into the conduit 18.

Drawing air pockets 38 and water pockets 40 through the conduit 18 enhances the performance of the energy harnessing device 10 significantly when compared to an energy harnessing device which does not comprise a conduit 18, such as screw-type prior art devices, which rely upon external drag forces alone. While the inventors do not wish to be bound by any particular theory, there may be several reasons for this.

First, due to the difference in density between air and water, the air pockets 38 within the conduit 18 have a natural tendency to reside in the uppermost sections of the conduit 18 which experience least external pressure and the water pockets 40 have a natural tendency to reside in the lowermost sections of the conduit 18. If the device 10 resides at the surface 34 of the body of water 8 so that the conduit 18 is approximately 50% submerged (as in FIG. 1) the air pockets 38 will tend to lie above the water line 34 and the water pockets 40 below the water line 34. The different regions of relatively high and low pressure moving through a body of water experiencing wave or tidal motion, or which is subject to current flow, act on the alternating pockets of high and low pressure within the conduit 18, i.e. the pockets of air 38 and water 40, so as to repeatedly force the pockets of air 38, which have a tendency to lie higher, downwards and allow the pockets of water 40, which tend to lie lower, to rise in a similar manner to a crankshaft. As a result of the areas of variable water pressure moving along the length of the device 10 and the fact that the conduit 18 is open along at least a portion of its length, the pockets of air 38 and water 40 within the conduit 18 are free to be pumped along the conduit 18 in the direction towards the rear opening 22 at the opposite end of the device 10.

Second, the difference in weight between the air pockets 38 and water pockets 40 within the conduit 18 may mean that as the energy harnessing device 10 and hence conduit 18 are rotated about the axis X that the relatively large weight of the water pockets 40 relative to the air pockets 38 will urge the energy harnessing device 10 to continue rotating. This may be due to the weight of the water pockets 40 being exerted on the internal wall of the conduit member 16 which defines the conduit 18.

Third, the provision of the opening 20 adjacent to the tether 14 such that it faces the direction of the incoming waves means that not only is the exterior surface of the conduit member 16 exposed to the drag forces of the movement of the body of water, but so too is a portion of the internal surface of the conduit member 16 (i.e. the surface which defines the conduit 18). By exposing a greater surface area of the conduit member 16 to the drag forces created by the wave motion of the body of water, the total drag force experienced by the conduit member 16 and hence the energy harnessing device 10 will be increased. This increase in drag force experienced by the energy harnessing device will increase the rotational force experienced by the energy harnessing device 10 and hence improve the performance of the device 10.

Fourth, as mentioned above, the rotation of the support member 12 and hence the conduit 18 causes water and air to be pumped from the opening 20 through the conduit 18 towards opening 22. As the air and water moves through the conduit 18 it will acquire momentum, at least a component of which is in a direction parallel to the axis X. Because the momentum of the air and water urges them to continue travelling in a direction parallel to the axis X towards the opening 22, the air and water may impart a force to the internal wall of the conduit member 16, which will urge the conduit member 16 and hence the support member 12 to continue rotating.

The action of passage of the water through the conduit 18 may be likened to that of a fly wheel. As water is pumped through the conduit 18 it gains linear momentum and kinetic energy. The linear momentum of the water urges the water against the internal wall of the conduit member 16 and hence the water applies a force to the internal wall of the conduit member 16. The force imparted by the water to the internal wall of the conduit member 16 converts some of the kinetic energy of the water into rotational motion of the conduit member 16 and support member 12. The ability of the water within the conduit 18 to ‘store’ linear momentum and kinetic energy which may be converted to rotational motion of the energy harnessing device 10 may be advantageous in embodiments of the invention which are used in conditions where the wave motion of the body of water is non-uniform. Non-uniformity of the wave motion of a body of water may be: changing wavelengths of the wave motion and a changing time period for one cycle of the wave motion. If at any given time the energy imparted to the energy harnessing device by the wave motion of the body of water decreases, energy stored in the linear motion of the water through the conduit 18 may be converted to rotational motion of the conduit member 16 and hence the energy harnessing device 10. This may partially compensate for the reduction in energy being transferred to the energy harnessing device 10 by the wave motion of the body of water until such a time as the force being exerted on the energy harnessing device 10 by the wave motion of the body of water increases.

A further factor which may contribute to the functioning of the device 10 of the present invention arises as a result of the wave motion of the body of water 8 causing water to slip past the energy harnessing device 10. The moving water exerts a drag force on the support member 12 and the exterior surface of the helical conduit member 16. Due to the helical or screw shape of the exterior surface of the conduit member 16, the drag force exerted on the exterior surface of the conduit member 16 causes the conduit member 16, and hence the support member 12, to experience a rotational force. The magnitude of the force depends in part upon the size and shape of the support member 12 and the conduit member 16, which can be enlarged or re-shaped to increase drag in the event that it was desired to increase the extent to which this factor contributes to the overall performance of the device 10. It should be appreciated however that prior art screw-type devices which relied solely or primarily upon drag effects often functioned inefficiently, at least in part as a result of the fact that wave motion typically follows a cyclical path.

FIG. 4 shows an alternative embodiment of an energy harnessing device according to the present invention. The embodiment shown in FIG. 4 differs from the embodiment previously described in that it comprises three similar helical conduit members 42 each having an opening at the end of the energy harnessing device 10 closest the tether 14 and an opening at the end of the energy harnessing device 10 which is remote to the tether 14. It will be appreciated that any number of helical conduits 42 may be used in accordance with the present invention. Increasing the number of conduits 42 will increase the total volume of water/air pumped along the helical conduits 42 per single rotation of the energy harnessing device 10.

Increasing the number of helical conduit members 42 will also increase the total surface area of the openings of the conduits which face the incoming waves of the body of water. Increasing the total surface area of the openings of the conduits will lead to an increase in the surface area of the internal walls of the conduits which can be upon which the drag force resulting from the wave motion of the body of water can be exerted. Increasing the surface area upon which the drag force of the water can be exerted will increase the total force which is applied to the energy harnessing device 10 by the wave motion of the body of water. This may in turn improve the performance of the energy harnessing device 10.

The performance of an energy harnessing device 10 according to the present invention with two helical conduit members which are spaced from one another along the support member by a distance equal to half the pitch of the helical conduit members (such that the helical conduit members form a double helix) is particularly effective. This is thought to be the case because the forces on each conduit member caused by the movement of water, both inside the conduit member, due to the movement of the water pockets within the conduit; and outside the conduit member, due to the wave motion of the body of water, are in phase with one another.

Tests have been conducted on a 1:50 scale model of a preferred embodiment of an energy harnessing device 10 according to the present invention. The support member 12 was 1.5 metres in length and 5 cm in diameter. The device 10 incorporated two conduit members 16, each 5 cm in diameter, wound helically around the outside of a centrally located support member 12. The total diametrical width of the support member 12 plus the helical piping 16 was 15 cm. The flexible piping which formed the conduit members 16 was wrapped around the support member 12 so that the pitch of the conduit members 16 was 80 cm (i.e. the distance along axis X between equivalent points along the helical piping). The conduit members 16 were spaced from one another by a distance equal to half their pitch so as to form a double helix arrangement. The scale model was tested under the following wave conditions: wave height (peak to trough)—5 to 10 cm at 1:50 scale and wavelength (peak to peak)—50 to 100 cm at 1:50 scale. The model rotated at speeds of up to 11 rotations per minute and generated the equivalent of around 70 kW of power at full scale at an estimated energy capture efficiency of less then 7% based on Froude correction. Further optimisation of various device characteristics should enable the energy capture efficiency to be further improved. It is currently anticipated that this may enable an equivalent full scale device (i.e. 75 m in length, support members and helical piping of 2.5 m diameter, helical pitch of 40 m) to generate more than 300 kW of power. An array of 5 such devices could therefore potentially generate more than 1500 kW of power assuming a 30% energy capture efficiency. As discussed above, increasing the length and/or diameter of the piping should further increase the power generation capacity of the device as compared to the scale model tested, and arranging the helical pitch of the piping so as to match as closely as possible the average predicted wavelength should maximise power generation efficiency.

Although any appropriate length may be chosen for an energy harnessing device 10, in some embodiments it may be preferable that the length of the device 10 is at least as long as the average predicted separation between adjacent waves. Because of this, the energy harnessing device 10 will always be supported by the crests of at least 2 adjacent waves. This helps to ensure that the axis X of the energy harnessing device 10 remains substantially horizontal. It is thought that when the axis X of the energy harnessing device 10 is horizontal that this optimises the passage of air and water pockets 38,40 through the conduit 18. For example, if the axis X was to be inclined relative to the horizontal such that the opening 20 near the tether 14 is below the opening 22 at the opposite end of the device 10 then energy may be wasted by the energy harnessing device 10 because energy is used to lift the water within the conduit 18 as it travels from opening 20 to opening 22. When the axis X is inclined from the horizontal such that the opening 20 is above the opening 22 it may be the case that the passage of air and water pockets 38,40 through the conduit 18 may be inhibited by the presence of a large amount of water within the conduit 18 at the rear end of the conduit 18 adjacent opening 22. Impeding the progress of air and water pockets 38,40 through the conduit 18 is likely to reduce the performance of the energy harnessing device 10.

It will be appreciated that the greater the length of the energy harnessing device 10, the greater the length of the conduit 18 and hence the greater the number (for a given pitch of helical conduit member 16) of air pockets 38 and water pockets 40 that will be within the conduit 18. Increasing the number of water pockets 40 and air pockets 38 within the conduit 18 should therefore increase the effect that the movement of the air and water pockets 38,40 within the conduit 18 will have on the energy harnessing device 10. This may in turn result in improved performance of the device 10.

It will be appreciated that any suitable pitch of the helical conduit member 16 (and hence the conduit 18) may be used. The optimum arrangement is for the pitch to approximately match the predicted average wavelength of the waves. For some embodiments of present invention that it is advantageous for the pitch of the conduit member 16 to be less than or approximately equal to the maximum predicted wavelength of the waves at a given location.

It will also be appreciated that any suitable diameter of the support member 12 may be used or that it may be omitted entirely if the conduit member 16 has sufficient structural strength and rigidity to retain its form during use. Furthermore, any suitable width of conduit member 16 may be used. Moreover, the conduit 18 may have any suitable cross-sectional area within the conduit member 16. The greater the width of the conduit member 16, the greater the exterior surface area of the conduit member 16 and hence the greater the force the wave motion of the body of water 8 will exert on the energy harnessing device 10, which may improve the performance of the device 10. Increasing the width of the conduit member 16 will also enlarge the cross-sectional area of the conduit 18 if the thickness of the wall of the conduit member 16 remains constant. The greater the cross-sectional area of the conduit 18, the greater the volume of the conduit 18 for a given length, and in turn, the greater the volume of the water pockets 40 and air pockets 38. Increasing the volume of the air and water pockets 38,40 will increase the effect that the movement of the pockets 38,40 through the conduit 18 will have on the performance of the energy harnessing device 10, which may further improve the performance of the device 10.

It will be appreciated that the openings 20,22 of the conduit 18 may have any appropriate shape or size. Increasing the size of the opening 20 which faces the oncoming waves will increase the surface area of the internal surface of the conduit member 16 which is exposed to the wave motion of the body of water 8 and will also promote the entrance of fluid, i.e. air and water, into the conduit 18. Increasing the surface area of the internal surface of the conduit member 16 which is exposed to the wave motion of the body of water will increase the drag force and the fluid displacement force that the air and water can exert on the energy harnessing device 10 due to wave motion of the body of water 8. This in turn may improve the performance of the energy harnessing device 10. Facilitating the ingress of air water into the conduit will promote the creation of air and water pockets 38,40 within the conduit 18, which will promote any beneficial effect that movement of the air and water pockets 38,40 through the conduit 18 has on the performance of the device 10. The shape of the openings 20,22 may also be chosen so as to promote the ingress/egress of water and air to/from the conduit 18. For example, a flow efficient elliptical or conical opening 20,22 may promote the ingress/egress of water and air to/from the conduit 18 compared to a tubular opening.

Furthermore, the opening 22 may have a reduced size compared to the size of the opening 20 or the conduit 18 may be provided with one or more constrictions. Providing the conduit 18 with a constriction (including the use of an opening 22 which is smaller than opening 20) will restrict the flow of the air pockets 38 and water pockets 40 through the conduit 18, which may be used to control the pressure or flow rate of the air and water within the conduit 18 and thereby provide a further means to optimise the performance of the device 10 in a body of water experiencing changing conditions.

It can be seen from FIG. 1 that in some embodiments of the present invention, the energy harnessing device 10 has an overall buoyancy (when the conduit 18 contains air pockets 38 and water pockets 40) which is such that the device 10 is semi-submerged. In the case shown in FIG. 1, the device 10 is semi-submerged such that approximately 50% of the device 10 lies above the water level 34 and approximately 50% of the device 10 lies below the water level 34. The buoyancy of the device 10 may be configured so that any suitable portion of the device 10 is submerged. For example, in some embodiments of the present invention it has been found to be advantageous for the energy harnessing device 10 to be at least around 25% submerged, more preferably at least around 50% submerged, and still more preferably at around 75% to 80% submerged. In other embodiments of the present invention it is advantageous for the energy harnessing device 10 to be entirely submerged just below the water surface 34, or in submerged to a more significant depth below the surface 34.

It will be appreciated that when a large proportion, or the entirety, of the energy harnessing device 10 is submerged beneath the water level 34, it may be difficult or impossible for air to be introduced into the conduit 18 via the openings 20,22. As previously discussed, the presence of discrete air and water pockets 38,40 within the conduit 18 are advantageous for improving the performance of the energy harnessing device 10. For this reason, the opening 20 may be provided with a snorkel-type arrangement or another suitable source of inlet air of some other suitable fluid or fluid mixture that is less dense, preferably significantly less dense, than water. The snorkel-type arrangement may take the form of part of the conduit 18 extending radially outward relative to the axis X to a radial distance which is greater than that of the rest of the conduit 18. It will be appreciated that in order for the snorkel-type arrangement to function it must extend to a radial distance from the X axis which is sufficient to enable it to extend above the water level 34 during part of the rotation cycle of the energy harnessing device 10. It follows that the radial distance to which the snorkel-type arrangement extends will be dependent upon the depth to which the energy harnessing device 10 is submerged and the predicted wave height of the body of water 8 in which the device 10 is to be deployed.

In a further alternative embodiment not depicted in the accompanying drawings, the openings 20,22 may be connected to one another so that the device 10 forms an essentially closed system. Upon initial activation of the device 10 the conduit 18 is charged with air and water so as to form the air and water pockets 38,40 along the length of the conduit 18. The device 10 is then deployed into a body of water at which point the air pockets 38 within the conduit 18 will tend to right themselves so that they lie higher than the water pockets 40. In embodiments of the device 10 designed to sit at the water line (as in FIG. 1), the air pockets 38 will tend to lie above the waterline 34 and the water pockets 40 will tend to lie below the waterline 34. Upon an incident wave passing over the device 10 the varying pressure of the wave along its length will cause the air and water pockets 38,40 resident within the conduit 18 to be pumped from the front end of the device 10 facing the incoming waves adjacent opening 20 to the opposite rear end of the device 10 adjacent opening 22. As air and water pockets 38,40 pass through the rear opening 22 they enter a return conduit (not shown in the Figures) through which they pass back to the front opening 20 ready for reintroduction into the conduit 18. The return conduit may be of any desirable size and shape to optimise performance of the device 10. For example, in some applications it will be desirable to ensure the return conduit is of sufficient internal diameter to minimise back pressure which might hinder the flow of the air and water pockets 38, 40 through the helical conduit 18. In other applications, it may be desirable for the return conduit to impose a degree of back pressure to restrict the flow of air and water exiting the helical conduit 18 and increase pressures within the helical conduit 18 in a similar manner to the constrictions to the rear opening 22 discussed above. Constrictions of this kind may be used in combination with a return conduit of reduced diameter as a means of further optimising the performance of the device 10 in changing water flow conditions.

It will be appreciated that although the described embodiments of the present invention comprise at least one conduit member 16 which is separate to the support member 12, this need not be the case. For example, the conduit member and support member may be unitary in nature. Furthermore, although the described embodiments show that the central support member 12 extends along the entire length of the conduit member(s), this need not be the case. For example, the conduit members may have sufficient rigidity such that the support member may only need to extend along part of the length of the conduit member(s) or may be entirely omitted. Also, the support member may be replaced by a number of smaller support members which together extend along part or substantially the entire length of the conduit member(s).

The support member and conduit member(s) may be made out of any suitable material, such as plastic, metal and/or a composite material. A monocoque construction may be used. The material of the support member and conduit members(s) may be chosen so as to give the energy harnessing device 10 a particular buoyancy and hence a particular submersion within the body of water. Additional floatation or buoyancy aids may also be integrated into the device 10.

Although the described embodiments of the energy harnessing device comprise a transducer having an alternator and a gearbox, with the transducer being situated at the end of the energy harnessing device remote from the tether, any suitable transducer may be used and it may provided at any desirable location. For example, any type of electrical power generator may be used. Also, the electrical power generator may be connected directly to a support member as opposed to via a gearbox. Furthermore, although the electrical power generator shown converts the rotational motion of the energy harnessing device into electrical power, any electrical power generator and appropriate linkage system may be used provided it is capable of converting the rotational motion of the energy harnessing device into electrical power. The transducer may be located at any position along the energy harnessing device. For example, the transducer may be located midway along the energy harnessing device or adjacent the tether. Moreover, energy may be harnessed by tapping into the fluid(s) flowing through the inside of the helical conduit and/or by attaching a rotary pump or the like to the device to transfer energy back to the shore, platform etc for conversion to electricity.

Although the conduit member of the described embodiments has a generally annular cross-section, this need not be the case. For example, the exterior surface of the conduit member may have any appropriate shape. For example, it may be generally fin-shaped such that the fin extends radially outwards relative to the axis X. Also, the exterior surface of the conduit member may incorporate other features, such as a roughened surface, to increase the surface area of the exterior surface of the conduit member. Increasing the surface area of the exterior surface of the conduit member will increase the surface area over which the drag force due to the wave motion of the body of water can act, thereby increasing the force the body of water exerts on the energy harnessing device and may then improve the performance of the energy harnessing device, particularly when the device is deployed in a body of water experiencing linear fluid flow as a result of tidal motion and/or current flow. Given the cyclical nature of wave motion which imposes limitations on the performance of prior art screw-type devices that rely on external drag alone, when the device is intended for use primarily in a body of water experiencing wave motion it may be advantageous to omit some or all of the aforementioned surface features so as to minimise drag and allow the effect of the waves on the pockets of air and water within the conduit to be the predominant mechanism by which wave energy is harnessed. Furthermore, the internal surface of the conduit member which defines the conduit may be any appropriate shape. For example, it may have a square, rectangular or triangular profile. Moreover, the device may incorporate any desirable number and design of peripheral wave guides to optimise the flow of air and water into the helical conduit(s) and over the surface of the device so as to maximise energy harnessing efficiency.

Although the described embodiments are tethered only once and at one end of the energy harnessing device, it will be appreciated that an energy harnessing device according to the present invention may be tethered at any point along its length and may be tethered by two or more tethers, for example, one tether at opposite ends of the device. Any suitable type of tethering may be adopted, such as a simple line or cable secured to a fixed structure, or more sophisticated intelligent mooring may be used whereby the orientation of the device relative to the prevailing waves can be controlled to optimise energy harnessing performance, or optionally a combination of both methods.

It will also be appreciated that the electrical power output from several energy harnessing devices according to the present invention may be combined. Multiple energy harnessing devices according to the present invention may be located at specific locations so as to maximise the wave energy that is harnessed from the body of water. For example, a plurality of devices may be stacked vertically at different depths to accommodate changing wave/tide/current flow conditions and/or distributed horizontally in a side-by-side and/or end-to-end arrangement to form arrays or ‘farms’ of devices. It is also within the scope of the present invention that several support members and conduit members may be attached to a single electrical power generator. A significant advantage of the device of the present invention is that its relatively simple and robust design makes it eminently suitable for incorporation into existing infrastructure such as offshore wind farms and production platforms.

1. An energy harnessing device comprising a substantially helical conduit which in use is arranged to float in a body of water including regions of varying pressure, the conduit defining a fluid flow path along its length and comprising a fluid inlet and a fluid outlet in fluid communication via said fluid flow path, said conduit being arranged so as to be rotatable about its longitudinal axis by the action of water of varying pressure contacting said helical conduit and driving fluid(s) along said fluid flow path.

2. A device according to claim 1, wherein the conduit is adapted to accommodate fluid(s) of varying pressure to be driven along the fluid flow path.

3. (canceled)

4. (canceled)

5. A device according to claim 1, wherein the pitch of the helical conduit member is configured to approximately match a predicted average wavelength of the body of water when including regions of varying pressure arising from wave motion.

6. (canceled)

7. A device according to claim 1, wherein the longitudinal length of the helical conduit member is greater than or equal to the predicted average wavelength of the body of water when including regions of varying pressure arising from wave motion.

8. (canceled)

9. (canceled)

10. A device according to claim 1, wherein the pitch of the helical conduit member is configured to be less than or equal to a predicted maximum wavelength of the body of water when including regions of varying pressure arising from wave motion.

11. (canceled)

12. (canceled)

13. (canceled)

14. (canceled)

15. (canceled)

16. (canceled)

17. A device according to claim 1, wherein the device is adapted to float in the body of water so that at least around 25% of the volume of the helical conduit is submerged below the average water line.

18. A device according to claim 1, wherein the device is adapted to float in the body of water so that substantially the whole volume of the helical conduit is submerged below the average water line.

19. A device according to claim 1, wherein the helical conduit is configured so that at least one of the fluid inlet and the fluid outlet is radially offset from the longitudinal axis of the helical conduit.

20. (canceled)

21. A device according to claim 1, wherein the fluid inlet is open to the surrounding environment so as to allow alternating volumes of air and water to flow into the fluid flow path defined by the helical conduit during rotation of the helical conduit.

22. A device according to claim 1, wherein the fluid inlet is defined by a protrusion extending radially outwardly from the helical conduit.

23. (canceled)

24. A device according to claim 1, wherein the fluid outlet is also in fluid communication with the fluid inlet via a return conduit which defines a return fluid flow path for fluid to flow from said outlet to said inlet.

25. A device according to claim 1, wherein the helical conduit is tethered to restrict displacement of the helical conduit along its longitudinal axis and/or out of the horizontal plane.

26. A device according to claim 25, wherein said tethering is effected by at least one line being secured to a fixed structure.

27. (canceled)

28. (canceled)

29. (canceled)

30. (canceled)

31. (canceled)

32. (canceled)

33. (canceled)

34. (canceled)

35. (canceled)

36. A method of harnessing energy from a body of water including regions of varying pressure, the method comprising
a. floating a device comprising a substantially helical conduit in said body of water, the helical conduit defining a fluid flow path along its length and comprising a fluid inlet and a fluid outlet in fluid communication via said fluid flow path,
b. introducing fluid(s) of varying pressure into said conduit so as to occupy at least a portion of said fluid flow path, and
c. arranging the helical conduit containing the fluid(s) of varying pressure to be contacted by said body of water of varying pressure so as to cause the helical conduit to rotate about its longitudinal axis and drive the fluid(s) of variable pressure along said fluid flow path.

37. A method according to claim 36, wherein the fluid(s) of varying pressure comprise alternating pockets of relatively high pressure fluid and relatively low pressure fluid.

38. (canceled)

39. A method according to claim 36, wherein the device is floated in the body of water so that at least around 25% of the volume of the helical conduit is submerged below the average water line.

40. A method according to claim 36, wherein the device is floated in the body of water so that substantially the whole volume of the helical conduit is submerged below the average water line.

41. A method according to claim 36, wherein the method comprises tethering the helical conduit to a fixed structure to restrict displacement of the helical conduit along its longitudinal axis.

42. (canceled)

43. (canceled)

44. A method according to claim 36, wherein the fluid inlet is open to the surrounding environment so that during rotation of the helical conduit alternating volumes of air and water can flow into the fluid flow path defined by the helical conduit.

45. A method according to claim 36, wherein the fluid outlet is also in fluid communication with the fluid inlet via a return conduit which defines a return fluid flow path for fluid to flow from said outlet to said inlet during rotation of the helical conduit.

46. (canceled)
